(19) United States
(12) Patent Application Publication
(10) Pub. No.: US 2005/0072286 A1
(43) Pub. Date: Apr. 7, 2005

(54) Knife holder traverser of corner cutting device

(76) Inventor: Chao-Tung Shih, Jhonghe City (TW)

Correspondence Address: Yi-Wen Tseng, 509 ROOSEVELT BLVD. #D306, FALLS CHURCH, VA, 22044, US

(21) Appl. No.: 10/677,314

(22) Filed: Oct. 3, 2003

(51) Int. Cl. B26D 5/08

(52) U.S. Cl. 83/549; 83/633; 83/686

(57) ABSTRACT

A knife holder traverser of a corner cutting device, having a bulk body and a knife holder traverser. The bulk body includes a hole for pivotally connecting the knife holder traverser. A positioning member is used between the knife holder traverser and the bulk body. The positioning member has at least one fixing part and a connecting part engageable with the fixing part. Thereby, the knife holder traverser can be positioned and embedded with various orientations. The bottom surface of the knife holder has at least two slots for receiving cutleries in different shapes. When a card is placed on a platform, by rotating the knife holder to change the cutlery with different orientation, the corner of the card can be chamfered or beveled by changing rotating.

### BACKGROUND OF THE INVENTION

1. Field of the Invention

The present invention relates in general to a knife holder traverser, and more particularly, to a cutting device applied for trimming corners of card or paper products. The cutting device rounds up or bevels the corner of a card by rotating the knife holder to change the cutlery with different orientations.

2. Description of the Related Art

The enhancement of computer and information technology and the development of graphic software, the homemade cards have become more and more popular. However, in addition to aesthetics, the profile of the card also provides an important visual effect. The invention of corner cutting device provides the resolution of corner trimming process.

In the Taiwan Patent Application No. 87205311, a multi-specification corner rounding device is disclosed. FIG. 1 shows a schematic drawing of the conventional corner rounding device, which comprises a base 10a, a corner rounding axis 11a, a press handle 12a and a fixing plate 13a. The base 10a includes a through hole 101a and a plurality of paper slots 101a connected with the through hole 101a. The through hole 101a accommodates the corner rounding axis 11a, while the rounding axis 11a has one end pivotally mounted to the press handle 12a and the other end serving as the blade cutting edge. The bottom of the press handle 12a is connected to the fixing plate 13a, which is engaged with the top surface of the base 10a. By pressing the top surface of the press handle 12a, the blade cutting edge of the corner rounding axis 11a is engaged with the cutting edge of the paper slot 102a of the base 10a, such that when a card is inserted in the paper slot 102a of the base 10a, the corner of the card is rounded.

Though the conventional corner rounding device provides the corner cutting function, it has the following drawbacks.
1. The cutting edge of the corner rounding axis 11a is engageable with the cutting edge of the paper slot 102a, such that when different shape of corner is required, the card has to be inserted along different direction relative to the paper slot 102a. The processing time is long. Further, as the corner rounding axis 11a is fixed inside of the through hole 101a, the degree of the corner cannot be determined from outside, and the processing mistake is inevitable to cause loss.
2. The upper part of the through hole 101a is circular, while the lower part of the through hole 101a is polygonal. Therefore, the manufacture of such corner rounding device is complex and costly.

### SUMMARY OF THE INVENTION

The present invention provides a knife holder traverser of a corner cutting device. By rotating the knife holder traverser, the cutlery with different orientation can be selected to cut the card or paper corner with desired shape.

The knife holder traverser of the corner cutting device includes a bulk body and a knife holder traverser. The bulk body has a hole therein for pivotally connecting the knife holder traverser. A positioning member is disposed between the knife holder traverser and the bulk body. The positioning member includes at least one fixing part and one connecting part opposing to the fixing part, such that the knife holder traverser can rotate to switch the position embedment in different direction. The bottom surface of the knife holder traverser includes at least two slots for receiving cutleries in different shapes.

### BRIEF DESCRIPTION OF ACCOMPANIED DRAWINGS

The above objects and advantages of the present invention will be become more apparent by describing in detail exemplary embodiments thereof with reference to the attached drawings in which:

FIG. 1 shows a conventional corner rounding device;

FIG. 2 shows a perspective exploded view of the knife holder traverser provided by the present invention;

FIG. 3 shows a perspective exploded view of the knife holder traverser from another viewpoint;

FIG. 4 shows an exploded view of a base of the knife holder traverser;

FIG. 5 shows an operation status of the knife holder traverser;

FIG. 6 shows another operation status of the knife holder traverser;

FIG. 7 shows an assembly of the knife holder traverser and the cutlery; and

FIG. 8 shows a second embodiment of the assembly.

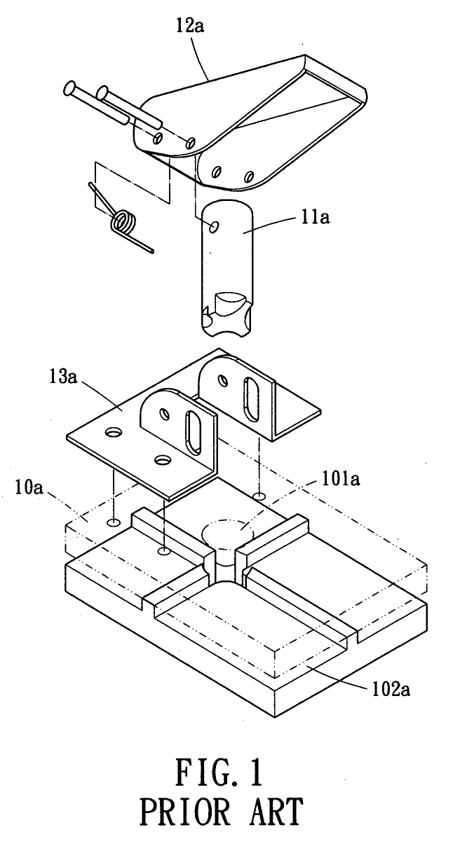

### DETAILED DESCRIPTION OF EMBODIMENT

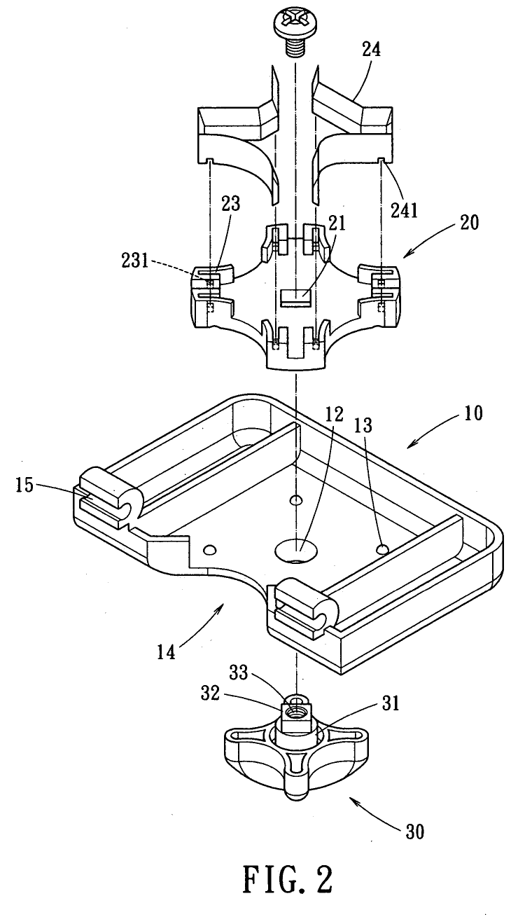

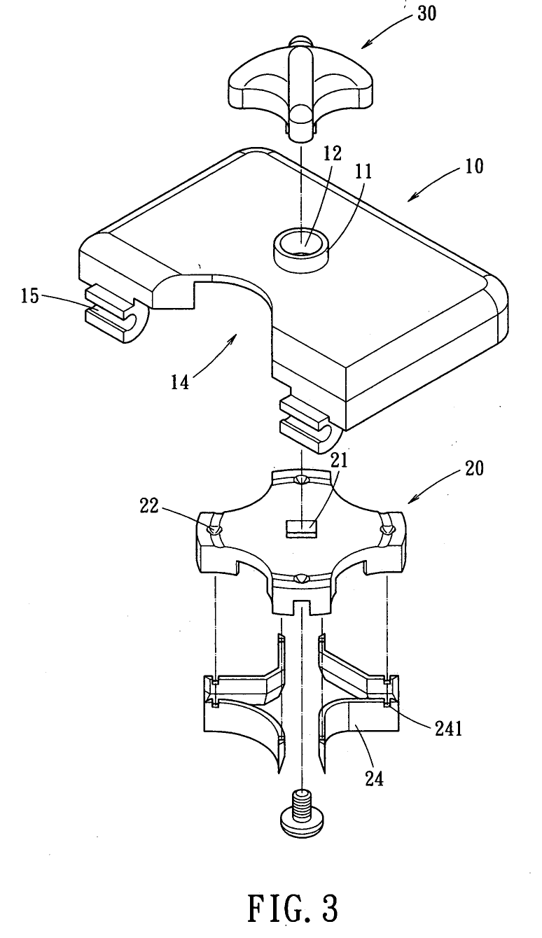

Referring to FIGS. 2 and 3, exploded views of a knife holder traverser observing from two viewing angles are illustrated. The knife holder traverser includes a bulk body 10 and a knife holder traverser 20.

The bulk body 10 includes an integrally formed rectangular frame. Protruding from the center of the bulk body 10 is a cylindrical column 11. The cylindrical column 11 includes a hole 12 therein. Recessed from a front surface of the bulk body 10 is a notch 14, and two slots 15 are formed at two sides of the recessed opening 14.

The knife holder traverser 20 includes a circular plate of which the periphery is cut with four symmetric portions, such that the remaining portion has a substantially cross configuration with four perpendicular extensions with proximate ends connected to each other at a common center and distal ends extending radially. The center of the cross plate is perforated with rectangular slot 21. A receiving slot 23 is formed on the distal end of each extension. Each of the receiving slots 23 includes a rib 231 protruding the center thereof. The receiving slots 23 are used to receive a cutlery 24 installed therein. The cutlery 24 is perpendicular to the extensions of the knife holder traverser 20. The cutleries 24 may have a curved shape or a trapezium shape. Notches 241 are formed at the bottom edge of the cutlery 24 and aligned with the ribs 231 while being installed in the receiving slots 23.

A positioning member is disposed between the bulk body 10 and the knife holder traverser 20. The positioning member includes a plurality of fixing parts 13 about the hole 12. The fixing parts 13 have a protruding semi-sphere or a recessed semi-spherical slot (not shown). In this embodiment, the fixing part 13 is formed with a protruding semi-sphere. A connecting part 22 is formed on the top surface of the knife holder traverser 20 with a specific distance to the hole 21. The connecting part 22 is engageable with each of the fixing parts 13 of the bulk body 10 to allow the knife frame traverser 20 changing direction for engagement.

The knife holder traverser 20 further comprises a turning knob 30 pivotally connected to the bulk body 10. The turning knob 30 includes a central protruding axis 31 which can be inserted into the hole 12 of the bulk body 10. The knob 30 further comprises a rectangular column 32 extending from the protruding axis 31. The rectangular column 32 includes a threaded hole 33 therein to be fastened by fasteners such as screws and similar devices.

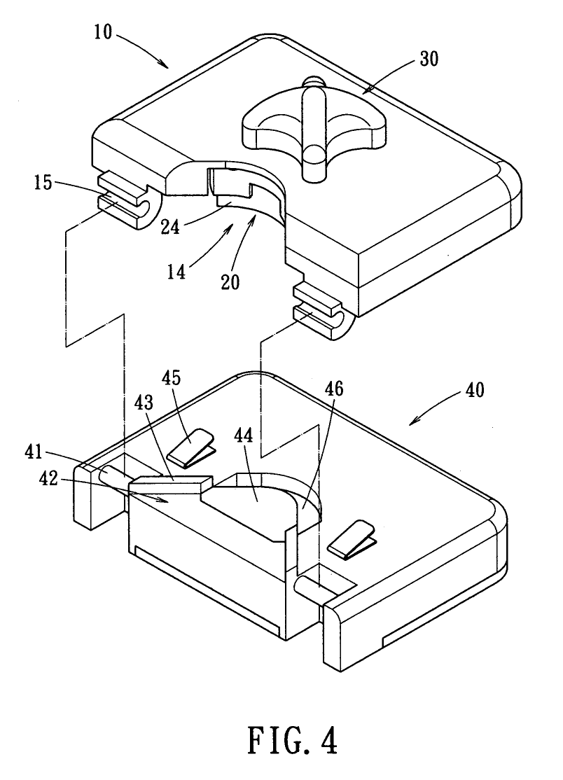

Referring to FIG. 4, the knife holder traverser 20 further comprises a base 40 pivotally connected to the bulk body. The base 40 includes two pivots 41 at two sides of the front edge thereof. The pivots 41 pivotally connect the bulk body 10 to the base 40. The top surface of the base 40 is a supporting platform 42 which has two blocking members 43 at two edges thereof. A cutting board 44 is disposed on the supporting platform 42 of the base 40. The cutting board 44 is made of soft materials and located right underneath the cutlery 24 of the knife holder traverser 20. Sheet springs 45 are formed on the base near two sides of the cutting board 44. The sheet spring 45 supports the bulk body 10 with a upward inclined status. The front edge of the cutting board further comprises an elongate trench 46 advantageous for guiding chippings.

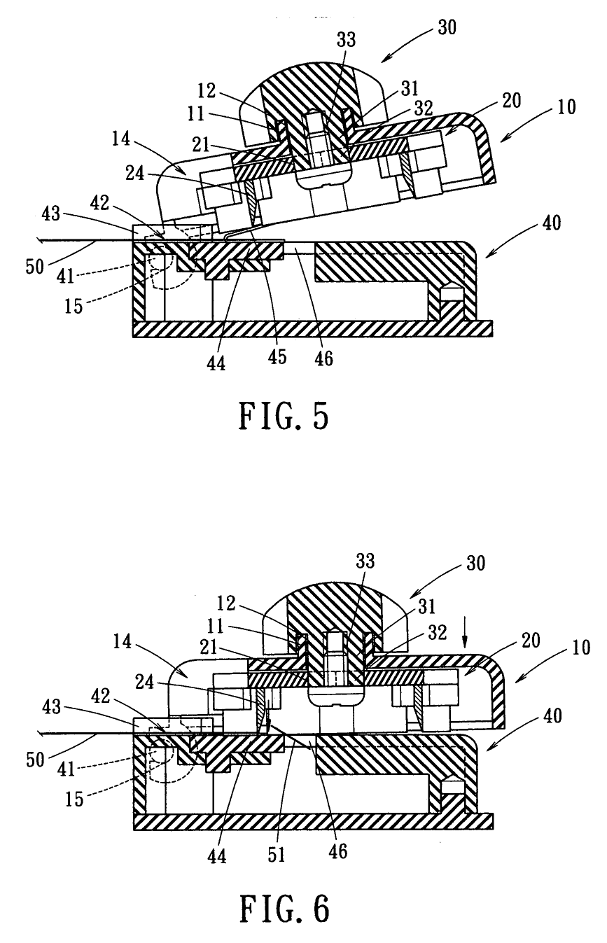

FIGS. 5 and 6 show the application status of the knife holder traverser 20. A card 50 is placed on the supporting platform 42 of the base, while the blocking edges 43 on the platform 42 prevent the card 50 to move laterally. The bulk body 10 is pressed rotating about the pivotal axis 41 of the base 40, such that the cutlery 24 installed in the knife holder traverser 20 moves downward along a curve. The edge of the cutlery 24 is in contact with the card 50 for cutting. When the edge of the cutlery 24 is in contact with the cutting board 44, the corner of the card 50 has been cut, while the chipping corner 51 has been removed from the card 50 and guided into the base 40 via the trench 46.

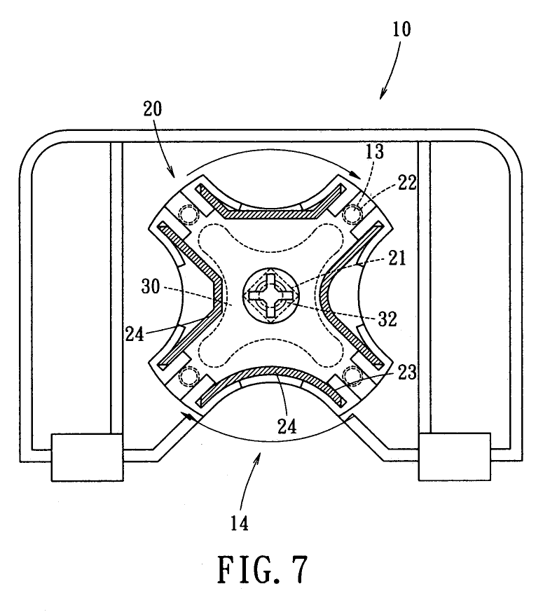

Referring to FIG. 7, when different corner structure of the card 50 is required, the knob 30 is rotated with different orientation, such that the cutlery 24 in the knife holder traverser 20 is oriented to provide different cutting effect of the card corner. The shape of the cutlery 24 can be observed from the, notch 14 of the bulk body 10 to prevent cutting mistake. In addition, the receiving slots 23 allow various types of cutleries to be installed therein. Therefore, a large variety of corner structures can be obtained.

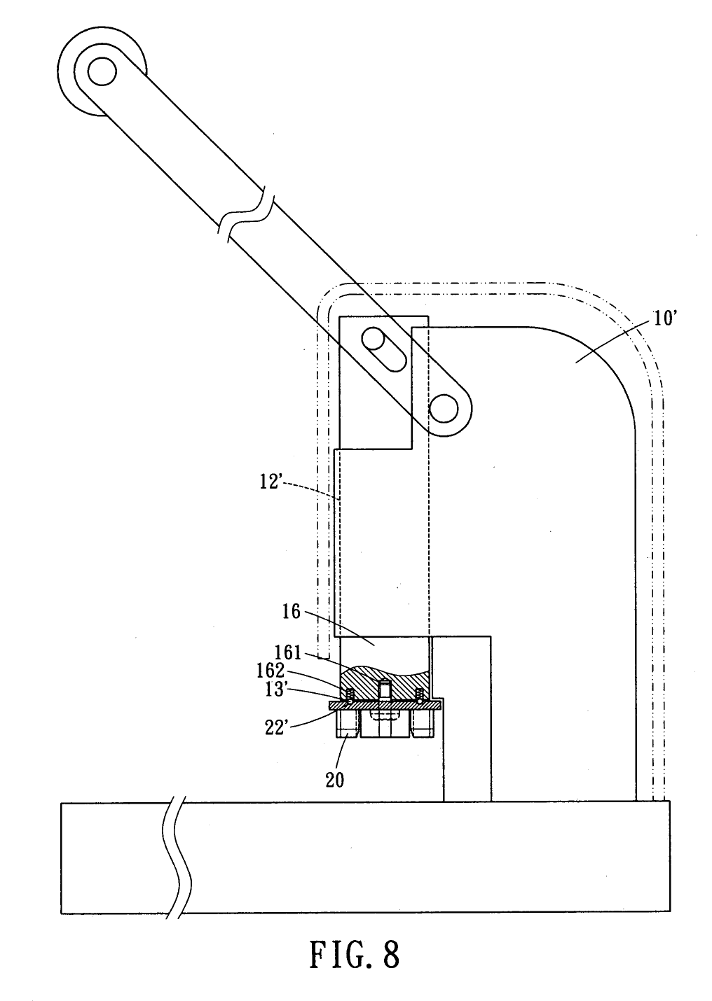

FIG. 8 shows a second embodiment of the present invention. The bulk body 10′ is perforated with a hole 12′ allowing a circular axis 16 to penetrate through. The circular axis 16 can move up and down. The bottom of the circular axis 16 includes a threaded hole 161 and a plurality of circular holes 162. The knife holder traverser 20 is pivotally connected to the bottom of the circular axis 16. Each circular hole 162 allows a spiral spring or a sphere disposed therein. The positioning member includes a fixing part 13′ disposed in the circular hole 162 of the circular axis 16 and the connecting part 12′ on the top surface of the traverser 20 an dengageable with the fixing part 13′. The fixing part 13′ includes a spiral spring and a sphere, while the connecting part 22′ includes a semi-circular slot.

According to the above, the present invention includes the following advantages.
1. By the rotation structure, the cutlery is oriented into different shape when the traverser is oriented into different direction. Various types of hole structures can thus be cut.
2. Different sizes or shapes of cutleries can be disposed in the traverser to perform corner cutting with different shapes.
3. The cutlery can be observed from the notch of the bulk body of the traverser, such that the cutting mistake can be avoided.

While the present invention has been particularly shown and described with reference to preferred embodiments thereof, it will be understood by those of ordinary skill in the art that various changes in form and details may be made therein without departing from the spirit and scope of the present invention as defined by the appended claims.

1. A knife holder traverser for a corner cutting device, comprising:
a bulk body;
a knife holder traverser pivotally connected to the bulk body, wherein the knife holder traverser is operative to carry at least two cutleries; and
a positioning member interfaced between the bulk body and the knife holder traverser, wherein the positioning member allows the knife holder traverser oriented along different directions.

2. The knife holder traverser as claimed in claim 1, wherein the bulk body includes a hole perforated through a center thereof, and a circular axis penetrating through the hole to provide pivotal connection.

3. The knife holder as claimed in claim 2 wherein the positioning member includes a fixing part and a connecting part, the fixing part is formed on a bottom surface of the circular axis, and the fixing part includes a spiral spring and a sphere.

4. The knife holder traverser as claimed in claim 1, includes at least two receiving slots for receiving different shapes of cutleries.

5. The knife holder traverser as claimed in claim 4, wherein each of the receiving slots includes a rib protruding from a center thereof to engage with the cutleries.

6. The knife holder traverser as claimed in claim 4, wherein the cutleries have curved or trapezium shape.

7. The knife holder traverser as claimed in claim 1, wherein the positioning member includes a fixing part formed on the bulk body and a connecting part formed on the top surface of the knife holder traverser.

8. The knife holder traverser as claimed in claim 7, wherein the fixing part comprises a protruding semi-spherical structure or a recessed semi-spherical slot.

9. The knife holder traverser as claimed in claim 1, further comprising a turning knob, wherein the bulk body includes a hole for pivotally connecting the turning knob, the knob is operative to rotate to change orientation of the knife holder traverser.

10. A corner cutting device, includes a knife holder traverser as claimed in claim 1, wherein the device further comprises a base pivotally connected to the bulk body, and a cutting board placed on the base right underneath the cutleries.
